(19) United States
(12) Patent Application Publication
(10) Pub. No.: US 2014/0046603 A1
(43) Pub. Date: Feb. 13, 2014

(54) ESTIMATING LOSSES IN A SMART FLUID-DISTRIBUTION SYSTEM

(71) Applicants: Vijay Arya, Bangalore (IN); Balakrishnan Narayanaswamy, Bangalore (IN)

(72) Inventors: Vijay Arya, Bangalore (IN); Balakrishnan Narayanaswamy, Bangalore (IN)

(73) Assignee: INTERNATIONAL BUSINESS MACHINES CORPORATION, Armonk, NY (US)

(21) Appl. No.: 13/569,473

(22) Filed: Aug. 8, 2012

(51) Int. Cl. G06F 19/00; G06F 17/18

(52) U.S. Cl. 702/50

(57) ABSTRACT

A method and associated systems for estimating losses in a fluid-distribution system, in which the fluid-distribution system may represented as a binary tree from which is generated a set of linear or nonlinear equations that express fluid losses as functions of measurements of characteristics of fluid flowing through the fluid-distribution system. Operations performed upon these equations to minimize measurement errors yield solutions that, when bounded by conditions derived from known physical and historical characteristics of the fluid-distribution system, allow inference of accurate loss locations and rates in the fluid-distribution system, even when the losses have not been measured directly or when measurements related to these leak losses contain measurement errors.

### TECHNICAL FIELD

The present invention relates to estimating losses in a fluid-distribution system.

### BACKGROUND

It can be difficult to detect and quantize losses that occur between measurement points in a fluid-distribution system, such as a system that distributes water, oil, or natural gas.

### BRIEF SUMMARY

A first embodiment of the present invention provides a method for estimating losses in a fluid-distribution system, wherein said fluid-distribution system comprises a plurality of locations and a plurality of distribution links, and wherein a first distribution link of said plurality of distribution links connects a first location of said plurality of locations to a second location of said plurality of locations, said method comprising:

a processor of a computer system receiving a plurality of measurements from a plurality of measurement devices, wherein a received measurement of said plurality of measurements identifies a characteristic of a fluid flowing through a measurement location of said plurality of locations, and wherein said plurality of measurements do not directly and accurately identify a fluid-loss location of said plurality of locations or a fluid-loss rate along a lossy distribution link of said plurality of distribution links; and

said processor analyzing said plurality of measurements to identify said fluid-loss location or said fluid-loss rate as a function of said plurality of measurements.

A second embodiment of the present invention provides a computer program product, comprising a computer-readable hardware storage device having a computer-readable program code stored therein, said program code configured to be executed by a processor of a computer system to implement a method for estimating losses in a fluid-distribution system, wherein said fluid-distribution system comprises a plurality of locations and a plurality of distribution links, and wherein a first distribution link of said plurality of distribution links connects a first location of said plurality of locations to a second location of said plurality of locations, said method comprising:

said processor of a computer system receiving a plurality of measurements from a plurality of measurement devices, wherein a received measurement of said plurality of measurements identifies a characteristic of a fluid flowing through a measurement location of said plurality of locations, and wherein said plurality of measurements do not directly and accurately identify a fluid-loss location of said plurality of locations or a fluid-loss rate along a lossy distribution link of said plurality of distribution links; and

said processor analyzing said plurality of measurements to identify said fluid-loss location or said fluid-loss rate as a function of said plurality of measurements.

A third embodiment of the present invention provides a computer system comprising a processor, a memory coupled to said processor, and a computer-readable hardware storage device coupled to said processor, said storage device containing program code configured to be run by said processor via the memory to implement a method for estimating losses in a fluid-distribution system, wherein said fluid-distribution system comprises a plurality of locations and a plurality of distribution links, and wherein a first distribution link of said plurality of distribution links connects a first location of said plurality of locations to a second location of said plurality of locations, said method comprising:

said processor of a computer system receiving a plurality of measurements from a plurality of measurement devices, wherein a received measurement of said plurality of measurements identifies a characteristic of a fluid flowing through a measurement location of said plurality of locations, and wherein said plurality of measurements do not directly and accurately identify a fluid-loss location of said plurality of locations or a fluid-loss rate along a lossy distribution link of said plurality of distribution links; and

said processor analyzing said plurality of measurements to identify said fluid-loss location or said fluid-loss rate as a function of said plurality of measurements.

A fourth embodiment of the present invention provides a process for supporting computer infrastructure, said process comprising providing at least one support service for at least one of creating, integrating, hosting, maintaining, and deploying computer-readable program code in a computer system, wherein the program code in combination with said computer system is configured to implement a method for estimating losses in a fluid-distribution system, wherein said fluid-distribution system comprises a plurality of locations and a plurality of distribution links, and wherein a first distribution link of said plurality of distribution links connects a first location of said plurality of locations to a second location of said plurality of locations, said method comprising:

said processor of a computer system receiving a plurality of measurements from a plurality of measurement devices, wherein a received measurement of said plurality of measurements identifies a characteristic of a fluid flowing through a measurement location of said plurality of locations, and wherein said plurality of measurements do not directly and accurately identify a fluid-loss location of said plurality of locations or a fluid-loss rate along a lossy distribution link of said plurality of distribution links; and

said processor analyzing said plurality of measurements to identify said fluid-loss location or said fluid-loss rate as a function of said plurality of measurements.

### BRIEF DESCRIPTION OF THE DRAWINGS

FIG. 1 shows the structure of a computer system and computer program code that may be used to implement a method for estimating losses in a fluid-distribution system.

FIG. 2 illustrates a tree-topology graphical representation of a fluid-distribution system.

FIG. 3 is a flow chart that illustrates steps of a method for estimating losses in a fluid-distribution system through sparsity-based solutions in accordance with embodiments of the present invention.

### DETAILED DESCRIPTION

A fluid-distribution system distributes a gas or liquid, such as water, natural gas, oil, or other distributable fluid, to a set of end-user delivery locations, and may comprise a set of distribution links, wherein each link in the set of distribution links carries a distributable fluid between a pair of distinct endpoint locations.

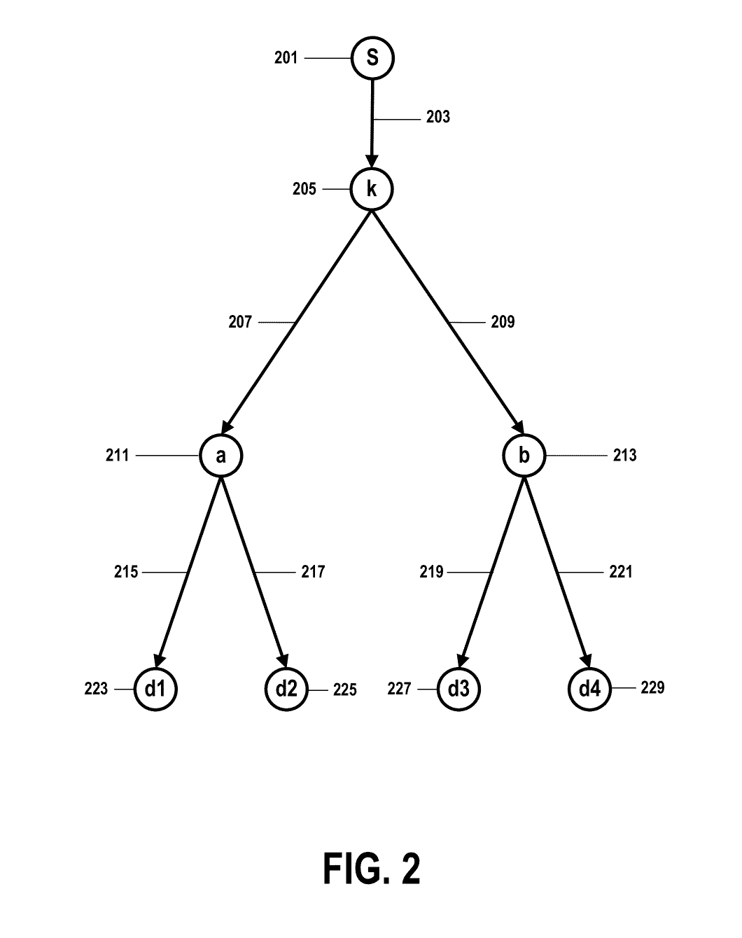

The topology of all or part of such a fluid-distribution system may be represented graphically as a tree that comprises a set of nodes and a set of paths, wherein each path in the set of paths connects two nodes of the set of nodes, and wherein the set of nodes comprises a root node, one or more leaf nodes, and, in nontrivial cases, one or more intermediate nodes. FIG. 2 illustrates an example of such a graphical tree representation.

A node of such a tree may represent a location of the fluid-distribution system and a path of such a tree may represent a distribution link of the fluid-distribution system. The tree's root node may represent a fluid source or intermediate source of the fluid-distribution system, such as a pumping station, and each leaf node of the tree may represent a final or intermediate fluid-destination point of the fluid-distribution system, such as a fluid consumer's home or business.

Such a tree may be a parent tree that comprises one or more subtrees, wherein a subtree of the one or more subtrees comprises a subset of the parent tree's nodes and a subset of the parent tree's paths, and wherein a path of the subtree connects a pair of the subtree's nodes. Such a subtree may represent a subsystem of the fluid-distribution system represented by the parent tree, wherein the subsystem distributes fluids from a source point represented by the subtree's root node to one or more destination points that are each represented by a leaf node of the subtree.

Because every subtree is itself a tree, any subtree that comprises a plurality of paths may also be a parent tree that comprises one or more subtrees. References herein to a tree thus also apply to a subtree, and to a subtree of a subtree.

A “smart” fluid-distribution system is a system wherein flow rates, flow volumes, or other types of measurable parameters may be measured by “smart” meters that may communicate measured data through a local connection or through a network to a utility company, service provider, or other entity. Smart meters may also be able to accumulate and store a plurality of measurements and receive communications from entities that respond to measured data. A smart meter may comprise a processor that may perform computations upon measurements and communicate results of these computations to a utility company, service provider, or other entity.

A smart meter may be a displacement water meter, a velocity water meter, an electromagnetic meter, a vibration sensor, or other type of measuring device known to those skilled in the art of fluid-distribution system design.

Fluid flowing through a distribution link may be characterized or quantized by characteristics such as flow rate or flow volume. These characteristics may be measured by conventional meters, by smart meters, or by other measurement devices installed at one or both of the endpoint locations that bound the distribution link, or may be derived from such measurements as a function of the fluid's physical properties.

If, for example, a pair of such measurement devices concurrently measure identical flow volumes at a link's entry endpoint and exit endpoint locations, it may be assumed that all fluid entering the link at the entry endpoint leaves the link without losses at the exit endpoint. Because measurable characteristics of a fluid flow may change over time, such measurements must be made close in time in order to accurately compare values of a characteristic sampled at different locations of a fluid-distribution system.

If a measurement device at a distribution link's exit endpoint location measures a value that is lower than a value of the same characteristic measured at the link's entry endpoint location, it may be assumed that some of the fluid that entered the link at the link's entry endpoint location did not leave the link through its exit endpoint location. This observation may indicate a “lossy” distribution link, wherein the lossy link loses fluid at a location along the path of the link.

A loss that occurs along the path of a lossy link may be the result of causes that comprise, but are not limited to, leakage, blockage, theft, or malfunction or failure of some component of the fluid-distribution system, including the system's meters, pumps, control mechanisms, and infrastructure, that occurs along the path of the lossy link, along the path of a different link, or at an endpoint or junction point that bounds a link.

Such a conclusion may require that synchronized and accurate measurements be made at both endpoints of a distribution link. Such synchronized and accurate measurements may not be available if, for example, reliable measurement devices are not installed at both endpoints of every distribution link, at every joint connecting multiple distribution links, and at every source and destination location. Such synchronized and accurate measurements may not be available if a measurement device fails, produces inaccurate, noisy, or inconsistent measurements, or is miscalibrated. Furthermore, the location of a loss may fall between measurement devices installed at locations that are too distant to localize the loss with sufficient precision.

Embodiments of the present invention address these problems through a novel method, system, computer program product, and service for estimating a location of a loss or a magnitude of a loss when a measurement produced by a measurement device comprised by the fluid-distribution is unavailable or inaccurate. A fluid-distribution system that lacks an accurate measurement device at a measurement location may be graphically represented as a tree that comprises a hidden or unmeasured variable. Such a graphical representation may be associated with an analogous set of linear or nonlinear equations that relate collected measurements to a hidden or unmeasured characteristic of the fluid-distribution system or of the fluid that the system distributes.

These and other types of graphical or mathematical representations enable inferential procedures that may be used to infer an accurate value of the hidden or unmeasured characteristic as a function of accurately measured data, and this inferred value may then be used to estimate a location or magnitude of a loss. These methods may comprise inferential procedures known to those skilled in the fields of analysis, machine learning, linear programming, and non-linear programming.

The accuracy of such inferences may be increased by considering extrinsic factors derived from knowledge of boundary conditions, prior knowledge, or other characteristics of the fluid-distribution system, or by consideration of logical principles like “Occam's Razor,” which reasons that a simplest solution of a set of candidate solutions is likely to be correct. Such extrinsic factors may include, but are not limited to, a distribution link's maintenance records or prior usage records; the age, type, construction, composition, design, or condition of a fluid-distribution system's infrastructure components; or a history of previous failures and repairs at locations along one or more links.

In embodiments of the present invention, such extrinsic factors and logical principles may be used to infer a probability of loss along a distribution link that has not been accurately described by collected measurements, or may be used to reduce a number of possible locations and magnitudes of such losses.

Persons skilled in the art of mathematical modeling or machine learning are familiar with inference algorithms that may be used to estimate hidden or unmeasured variables in graphical models and similar representations of data sets. Such well-known algorithms may comprise, but are not limited to: linear and nonlinear programming, variational Bayesian methods (ensemble learning), belief propagation (sum-product message passing), Markov chain Monte Carlo and Gibbs sampling algorithms, and junction tree-decomposition methods.

Variational Bayesian methods, for example, infer characteristics of unobserved variables in a statistical model that might be represented by a graphical model, and belief propagation is a type of message-passing algorithm that performs inference upon a graphical model that may comprise a binary tree or a directed graph. Embodiments of the present invention may select from these and similar algorithms based on the way an algorithm reconciles computational overhead and precision, and upon an algorithm's relative efficiency with an expected size or an expected complexity of a data set represented by a graphical model.

The present invention may use any of these or similar methods to infer a location or a magnitude of a loss at a location comprised by a fluid-distribution system, wherein a characteristic of a fluid flow comprised by the fluid-distribution system has not been accurately measured. These inferences may be made by graphically modeling the system as one or more tree data structures, reading one or more sets of measurements from smart meters installed at locations of the distribution system, and inferring the existence, location, or magnitude of a loss at a location comprised by the fluid-distribution system or along a distribution link comprised by the fluid-distribution system through the application of mathematical procedures or algorithms described above or as a function of characteristics of the fluid-distribution system.

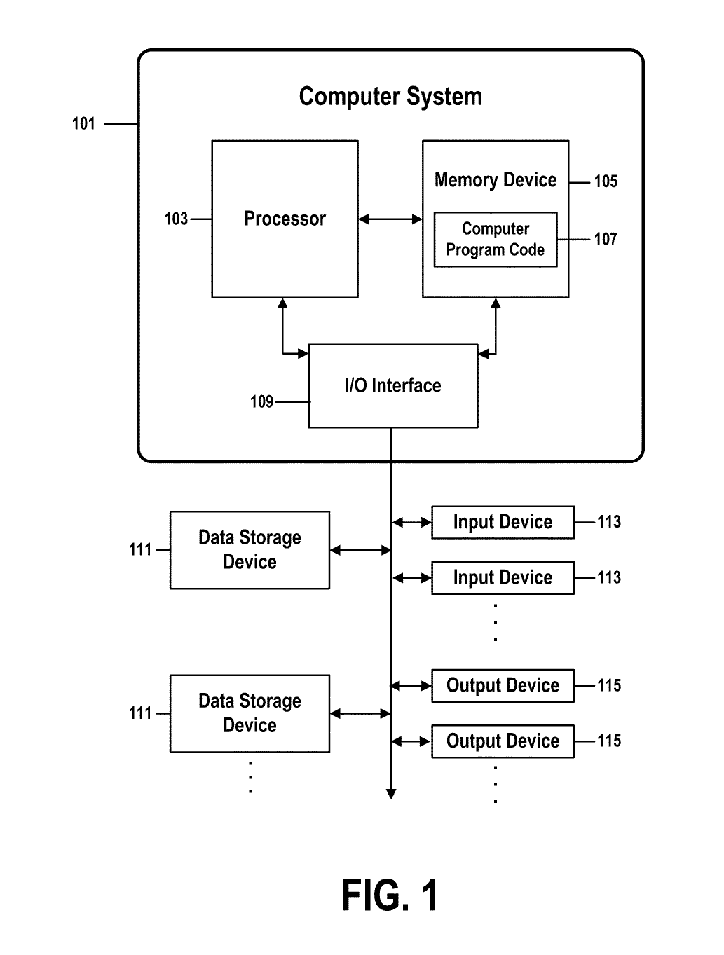

FIG. 1 shows the structure of a computer system and computer program code that may be used to implement a method for estimating losses in a fluid-distribution system. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, in one embodiment, the present invention may take the form of a computer program product comprising one or more physically tangible (e.g., hardware) computer-readable medium(s) or devices having computer-readable program code stored therein, said program code configured to be executed by a processor of a computer system to implement the methods of the present invention. In one embodiment, the physically tangible computer readable medium(s) and/or device(s) (e.g., hardware media and/or devices) that store said program code, said program code implementing methods of the present invention, do not comprise a signal generally, or a transitory signal in particular.

Any combination of one or more computer-readable medium(s) or devices may be used. The computer-readable medium may be a computer-readable signal medium or a computer-readable storage medium. The computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium or device may include the following: an electrical connection, a portable computer diskette, a hard disk, a random access memory (RAM), a read-only memory (ROM), an erasable programmable read-only memory (EPROM or flash memory), Radio Frequency Identification tag, a portable compact disc read-only memory (CD-ROM), an optical storage device, a magnetic storage device, or any suitable combination of the foregoing. In the context of this document, a computer-readable storage medium may be any physically tangible medium or hardware device that can contain or store a program for use by or in connection with an instruction execution system, apparatus, or device.

A computer-readable signal medium may include a propagated data signal with computer-readable program code embodied therein, for example, a broadcast radio signal or digital data traveling through an Ethernet cable. Such a propagated signal may take any of a variety of forms, including, but not limited to, electro-magnetic signals, optical pulses, modulation of a carrier signal, or any combination thereof.

Program code embodied on a computer-readable medium may be transmitted using any appropriate medium, including but not limited to wireless communications media, optical fiber cable, electrically conductive cable, radio-frequency or infrared electromagnetic transmission, etc., or any suitable combination of the foregoing.

Computer program code for carrying out operations for aspects of the present invention may be written in any combination of one or more programming languages, including, but not limited to programming languages like Java, Smalltalk, and C++, and one or more scripting languages, including, but not limited to, scripting languages like JavaScript, Perl, and PHP. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN), a wide area network (WAN), an intranet, an extranet, or an enterprise network that may comprise combinations of LANs, WANs, intranets, and extranets, or the connection may be made to an external computer (for example, through the Internet using an Internet Service Provider).

Aspects of the present invention are described above and below with reference to flowchart illustrations and/or block diagrams of methods, apparatus (systems) and computer program products according to embodiments of the present invention. It will be understood that each block of the flowchart illustrations, block diagrams, and combinations of blocks in the flowchart illustrations and/or block diagrams of FIGS. 1-4 can be implemented by computer program instructions. These computer program instructions may be provided to a processor of a general purpose computer, special purpose computer, or other programmable data-processing apparatus to produce a machine, such that the instructions, which execute via the processor of the computer or other programmable data-processing apparatus, create means for implementing the functions/acts specified in the flowchart and/or block diagram block or blocks.

These computer program instructions may also be stored in a computer-readable medium that can direct a computer, other programmable data-processing apparatus, or other devices to function in a particular manner, such that the instructions stored in the computer-readable medium produce an article of manufacture, including instructions that implement the function/act specified in the flowchart and/or block diagram block or blocks.

The computer program instructions may also be loaded onto a computer, other programmable data-processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

The flowchart illustrations and/or block diagrams FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, wherein the module, segment, or portion of code comprises one or more executable instructions for implementing one or more specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts, or combinations of special-purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for estimating losses in a fluid-distribution system in accordance with embodiments of the present invention, and may implement other embodiments described in this specification, including the methods illustrated in FIGS. 1-4. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for estimating losses in a fluid-distribution system.

Any of the components of the present invention could be created, integrated, hosted, maintained, deployed, managed, serviced, supported, etc. by a service provider who offers to facilitate a method in conformance with embodiments of the present invention. Thus the present invention discloses a process for deploying or integrating computing infrastructure, comprising integrating computer-readable code into the computer system 101, wherein the code in combination with the computer system 101 is capable of performing a method for estimating losses in a fluid-distribution system.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

FIG. 2 illustrates a tree-topology graphical representation of a fluid-distribution system. FIG. 2 comprises objects identified by reference numbers 201-229.

In FIG. 2, smart meters are represented as circled nodes of the tree and comprise source meter S 201, intermediate meters k 205, a 211, and b 213, and destination meters d1 223, d2 225, d3 227, and d4 229.

In this example, the tree of FIG. 2 represents a distribution link of the fluid-distribution system that connects a pair of meters of the fluid-distribution system as a directional path 203, 207, 209, 215, 217, 219, or 221. Each distribution link is bounded by an upstream meter at a point of fluid entry to the link and by a downstream meter at a point of fluid exit from the link. The direction of fluid flow through a link from the link's point of entry to the link's point of exit is represented in the figure by a direction of an arrowhead shown on a path that corresponds to the link in the fluid-distribution system.

Link k-b, for example, is bounded by upstream meter k and downstream meter b, and fluid flowing through link k-b represented by path 209 in FIG. 2 flows down the page from meter k represented by node 205 to meter b represented by node 213 in the direction of the arrowhead of path 209. In FIG. 2, smart meters represented by nodes 201, 205, 211, 213, and 223-229 are arbitrarily defined as volume-of-flow meters, but in other implementations, these meters could record other types of data, such as fluid velocity, fluid temperature, fluid pressure, or some combination thereof.

The tree shown in FIG. 2 represents a fluid-distribution system wherein distribution link S-k 203 is bounded by meters S 201 and k 205, distribution link k-a 207 is bounded by meters k 205 and a 211, distribution link k-b 209 is bounded by meters k 205 and b 213, distribution link a-d1 215 is bounded by meters a 211 and d1 223, distribution link a-d2 217 is bounded by meters a 211 and d2 225, distribution link b-d3 219 is bounded by meters b 213 and d3 227, and distribution link b-d4 221 is bounded by meters b 213 and d4 229.

In other embodiments, meters may be distributed in a different pattern, the boundaries of distribution links may be identified according to a different method, or some distribution links may not be bounded by meters. Distribution links may be combined sequentially to logically form larger links or may be subdivided into sets of logical sublinks. Distribution link S-b, for example, might comprise links 203 and 209 and would be bounded by meter S 201 and meter b 213.

In other embodiments, a fluid-distribution may be represented by a different graphical model or a different type of graphical model, or may not be represented by a graphical model.

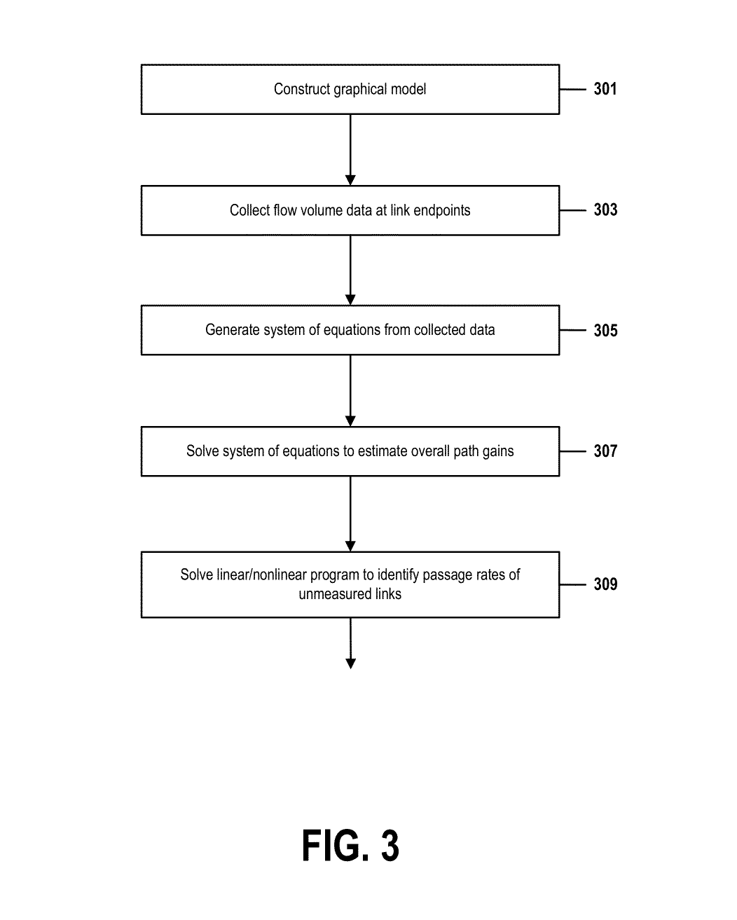

FIG. 3 is a flow chart that illustrates steps of a method for estimating losses in a fluid-distribution system through sparsity-based solutions in accordance with embodiments of the present invention. FIG. 3 comprises steps 301-309. Any of these steps may be performed by a single processor of a computer system or may be divided among a plurality of processors of a computer system or among a plurality of computer systems. In some embodiments, all or some of these processors and computer systems may be distributed throughout the fluid-measurement system, may be embedded or attached to measurement devices, or may be located at a location distinct from that of the fluid-distribution system.

In step 301, a graphical representation a fluid-distribution system is designed according to the methods described above. In graphical representation shown in the example of FIG. 2, the represented fluid-distribution system may comprise a smart meter at each of nodes 201, 205, 211, 213, and 223-229, but accurate measurements may not be consistently available from every one of these meters. In other embodiments, a fluid-distribution system may be represented by multiple graphical representations, a fluid-distribution system may be represented by different types of graphic representations, or a fluid-distribution system may not be represented graphically.

Step 303 describes the step of collecting measurements from measurement locations that each bound a distribution link of the smart fluid-distribution system graphically represented by FIG. 2. These measurements are collected from smart meters that may report a measurement in real time or that may have a response latency time low enough to approximate real-time reporting, such that the measurements may allow the deduction of information about fluid flows, including the location and magnitude of losses, that is approximately accurate at the times at which the measurements are measured or reported. These measurements may comprise, but are not limited to, fluid flow rates, fluid flow volumes, or other types of measurable data.

A set or a subset of these measurements, wherein the set or subset comprises at least one measurement from each of at least two of the smart meters, may be collected at times that are nearly identical or that are synchronized. This timing constraint may facilitate conclusions about fluid flow between measurement locations of the at least two meters, or at other locations in the fluid-distribution system, at approximately the times at which the measurements are measured or reported.

If it is not possible to collect a set of measurements within a threshold time span, embodiments of the present invention that analyze a sufficient number of accurate measurements may be able to use mathematical or statistical methods to identify and correct errors in other measurements caused by a lack of synchronization of measurement-collection times.

In some embodiments, multiple sets or subsets of these measurements may be collected over a longer period of time and analyzed jointly to provide additional measurement data that may be able to increase the accuracy or precision of loss estimates. The measurements that comprise a same set or subset of the multiple sets or subsets, however, should conform to the synchronization and timing constraints described above. Each set or subset of the multiple sets or subsets may comprise measurements from a different subset of the set of smart meters 201, 205, 211, 213, and 223-229.

Steps 305-309 describe embodiments of the present invention that enable the identification of a distribution link along which high loss occurs, even when the measurements collected in step 303 do not directly or accurately identify such a link or loss.

In a large-scale fluid-distribution system, a small number of “lossy” distribution links may have high losses due to damage, blockage, failure or malfunction, theft, intrinsic inefficiencies, or for other reasons. But if fluid flowing into and out of such a lossy link is not measured directly and accurately by a pair of meters located at opposite ends of the link, such losses may not be easily or quickly detected, located, or quantified. In a general case, identifying such losses and such lossy links requires a method that uses functions of collected meter measurements of unknown accuracy to correct measurement inaccuracies and to infer losses occurring along links that are not measured or that are measured by a meter of unknown reliability.

In an actual, possibly lossy, fluid-distribution system, wherein actual measurements may be subject to errors caused by noise, may be inaccurate or inconsistent for other reasons, or may not be available at certain locations or at certain times, a measured value may differ from an ideal measured value that would be expected in a perfect, noiseless, and lossless system, and neither the measured nor the ideal value may identify a true value that would accurately characterize an actual flow of fluid through the actual, possibly lossy, system.

Such an actual system, therefore, may be at least partly characterized by hidden or unknown true values of characterizing parameters, and these hidden or unknown true values must be identified in order to accurately estimate the location and magnitude of a loss, leakage, or blockage. The principles of sparsity described herein dictate that these hidden or unknown true values may be estimated by minimizing the number of nonzero discrepancies between true and measured values.

This minimization function may be an example of a computationally infeasible combinatorial problem that cannot be solved in polynomial time. Embodiments of the present invention solve this problem by substituting computationally feasible methods that may identify a correct solution in a fluid-distribution system that meets certain criteria that may comprise sparsity constraints. These computationally feasible methods include L0 minimization, L1 minimization, and L2 minimization, wherein L1 minimization may, when applied to a system of linear equations, produce a minimized solution to an analogous combinatorial problem in systems that comprise noiseless measurement devices, and L2 minimization may, when applied to a system of analogous nonlinear equations, produce a minimized solution to a combinatorial problem in systems that comprise noisy measurement devices.

In steps 305-309, embodiments of the present invention implement this novel technique through an optimization or inference procedure that derives a set of linear or nonlinear equations that may be a function of a graphical model created in step 301 and may be a further function of possibly inaccurate measurements collected in step 303. A set of solutions to this set of equations may then be reduced to an optimal “minimized” solution (or a near-optimal approximation of the optimal solution) by solving a linear or nonlinear program based on the set of equations, wherein this minimized solution is an optimal “sparsest” solution that is most likely to accurately estimate the location and magnitude of losses in the fluid-distribution system. This optimization comprises minimizing the magnitude of errors in the collected measurements, and may further comprise applying well-known minimization like those described above in order to identify an approximate solution.

In general, a sparsest solution may not be unique and may not be a correct solution. But when a fluid-distribution system comprises a relatively small number of losses, as is often the case in real-world systems, solving for a sparsest solution may be an efficient way to identify an optimal or near-optimal solution most likely to accurately estimate locations and magnitudes of losses. Even when a system suffers from a larger number of losses, this method can be effective when the losses are not clustered near a branch location or a junction location of the fluid-distribution system.

Formal inferential methods may further enable estimation, in a system that may be graphically represented as a tree, of the values and distributions of hidden or unmeasured variables in the tree as a function of a subset of measured values. Thus, in the embodiments of FIGS. 2 and 3, if steps 305-309 identify multiple likely sparse solutions, or identify a sparsest solution that is not a correct solution, it may be possible to further infer a unique, correct, or most likely solution by considering “prior information” about the fluid-distribution system. As described above, well-known inference algorithms that may perform such functions comprise, but are not limited to: belief propagation (sum-product message passing), variational Bayesian methods (ensemble learning), Markov chain Monte Carlo and Gibbs sampling algorithms, and junction tree-decomposition methods.

In step 305, a subset of data set of measurements collected in step 301 may be used to generate a system of linear equations. This generating may comprise a function of flow-conservation equations well-known to those skilled in the art of fluid dynamics, analysis, or fluid-distribution system design. If the complexity of the fluid-distribution system is high, embodiments of the present invention may instead generate a system of nonlinear equations that are solved with methods that may comprise L2 minimization, and wherein those methods may be analogous to those described below.

In one method of generating a system of linear equations, a distribution link i is associated with a unitless passage rate αᵢ that identifies a quantity OutFlowRateᵢ of fluid flowing out of link i as a function of a quantity InFlowRateᵢ of fluid flowing into link i. In this example, we define a passage rate αᵢ of distribution link i as:

αᵢ=OutFlowRateᵢ/InFlowRateᵢ

where InFlowRateᵢ identifies a flow rate of liquid into distribution link i and OutFlowRateᵢ identifies a flow rate of liquid out of distribution link i. In other embodiments, passage rate may be defined differently, or different characteristics of fluid-flow through link i, such as volume of flow, may be analyzed in a similar manner. In an example, if measurement devices measure an input flow of 50 gallons/second flowing into link i and an output flow of 45 gallons/second flowing out of link I, then αᵢ=(45 gallons/second/50 gallons/second)=0.9, which represents a passage rate of 90%.

In an example based the method of step 305 and FIG. 2, we wish to determine four root-to-leaf (initial source-to-final destination) passage rates α_{S-d1}, α_{S-d2}, α_{S-d3}, and α_{S-d4}, wherein: α_{S-d1} identifies a passage rate between meter S 201 and meter d1 223 along a path that comprises distribution links 203, 207, and 215; α_{S-d2} identifies a passage rate between meter S 201 and meter d2 225 along a path that comprises distribution links 203, 207, and 217; α_{S-d3} identifies a passage rate between meter S 201 and meter d3 227 along a path that comprises distribution links 203, 209, and 219; and α_{S-d4} identifies a passage rate between meter S 201 and meter d4 229 along a path that comprises distribution links 203, 209, and 221.

In this example, the passage rates of all distribution links 203, 207, 209, 215, 217, 219, and 221 of FIG. 2 may be accurately estimated if a set of known accurate measurements are collected from all meters 201, 205, 211, 213, and 223-229, and wherein all measurements collected at these meters are made at times that fall within a time span small enough that the set of measurements approximate a set of simultaneous measurements of a single fluid flow. The upper threshold of such a time span is an implementation-dependent value that may be determined by the fluid-distribution system's specific flow characteristics, topology, meter placement, actual fluid inflow and consumption patterns, or other factors.

In a trivial example, it is possible to compute a passage rate of a distribution link α_{S-d1} that is bounded by a pair of accurate meters S 201 and d1 223 as a function of a pair of approximately concurrent readings from the two accurate bounding meters 201 and 223. In this case, a difference between a measured input value and a measured output value directly identifies a loss of fluid that occurs along the distribution link between the input meter and the output meter, and a passage rate may be derived from these values through the method described above

It is not as simple, however, to identify a passage rate across a more complex path that comprises multiple, possibly unmeasured or inaccurately measured, distribution links, junctions, parallel loss points, or other complicating factors. In FIG. 2, for example, if meter b 213 does not produce accurate measurements, a loss along distribution link 209 could not be easily distinguished from a loss along link 219 or along link 221.

Given the fluid-distribution system and graphical representation of FIG. 2, step 305 of FIG. 3 might thus entail generating systems of linear or nonlinear equations that are functions of synchronized sets of measurements collected in step 301, and wherein each equation in the system of equations may correspond to one set of synchronized measurements.

In the current example, a set of collected measurements comprises one measurement from each meter of the set of meters 201, 205, 211, 213, and 223-229, wherein all measurements of this set of measurements are made within a span of time that is short enough to allow the set of measurements to approximate simultaneous measurements of a single flow through the measured links.

Here, collected measurement m(S,t0) is a volume of flow measurement made by meter S at time t0, collected measurement m(d1,t1) is a volume of flow measurement made by meter d1 223 at time t1, collected measurement m(d2,t2) is a volume of flow measurement made by meter d2 225 at time t2, collected measurement m(d3,t3) is a volume of flow measurement made by meter d3 227 at time t3, collected measurement m(d4,t4) is a volume of flow measurement made by meter d4 229 at time t4, collected measurement m(k,t5) is a volume-of-flow measurement made by meter k 205 at time t5, collected measurement m(a,t6) is a volume-of-flow measurement made by meter a 211 at time t6, collected measurement m(b,t7) is a volume-of-flow measurement made by meter b 213 at time t7, and measurement times t0, t1, t2, t3, t4, t5, t6, and t7 are sufficiently close to allow the set of eight measurements to approximate a set of simultaneous measurements of a same flow.

If all these measurements are available and accurate, passage rates may be identified for link 203 between meter S 201 and meter k 205, for link 207 between meter k 205 and meter a 211, for link 209 between meter k 205 and meter b 213, for link 215 between meter a 211 and meter d1 223, for link 217 between meter a 211 and meter d2 225, for link 219 between meter b 213 and meter d3 227, and for link 221 between meter b 213 and meter d4 229.

These calculations thus identify a set of directly measured passage rates:

αₖ=m(k,t1)/m(S,t0)=passage rate over link 203

αₐ=m(a,t6)/m(k,t5)=passage rate over link 207

α_{b}=m(b,t7)/m(k,t5)=passage rate over link 209

α_{d1}=m(d1,t1)/m(a,t6)=passage rate over link 215

α_{d2}=m(d2,t2)/m(a,t6)=passage rate over link 217

α_{d3}=m(d3,t3)/m(b,t7)=passage rate over link 219

α_{d4}=m(d4,t4)/m(b,t7)=passage rate over link 221

In another example, if a set of approximately simultaneous measurements is collected from source meter S 201 and from the four destination meters d1 223, d2 225, d3 227, and d4 229, one may attempt to similarly identify source-to-destination passage rates (or “path gains”) α_{S-d1}, α_{S-d2}, α_{S-d3}, α_{S-d4} along the four compound distribution links that begin at source S 201 and that each end respectively at one of destinations d1 223, d2 225, d3 227, or d4 229:

α_{S-d1}=m(d1,t1)/m(S,t0)

α_{S-d2}=m(d2,t2)/m(S,t0)

α_{S-d3}=m(d3,t3)/m(S,t0)

α_{S-d4}=m(d4,t4)/m(S,t0)

Using these measurements and passage rates to more precisely identify the location and magnitude of losses may not be as straightforward, however, if reliable measurements are not available from intermediate junction locations that join more than two distribution links. If, for example, meters k 205, a 211, and b 213 are not available or produce unreliable measurements, it may not be clear whether a leak between meter S 201 and meter d1 223 is located along link 203, link 207, or link 215.

The procedure of step 305 addresses this problem by estimating passage rates for a distribution link 203, 207, 209, 215, 217, 219, or 221 when reliable measurements are not available from every node along a path comprised by the link. In this example, this task requires the derivation of a set of linear equations. In other examples, analogous nonlinear equations or a combination of analogous linear and analogous nonlinear equations may be derived.

In this example, the set of linear equations comprises equation (1), which is a straightforward application of the law of flow conservation, which states that the sum of all flows into a line must equal the sum of all flows out of the line, wherein such flows comprise losses that occur along the line. Linear equations (2)-(5) are derived from the observation that, if a distribution link comprises two or more sublinks, the passage rate of the distribution link is the product of the passage rates of the sublinks.

$$\begin{matrix}m ( S , t 0 ) = \frac{m ( d 1 , t 1 )}{{α}_{S - d 1}} + \frac{m ( d 2 , t 2 )}{{α}_{S - d 2}} + \frac{m ( d 3 , t 3 )}{{α}_{S - d 3}} + \frac{m ( d 4 , t 4 )}{{α}_{S - d 4}} & ( 1 ) \\ {α}_{S - d 1} = {α}_{k} * {α}_{a} * {α}_{d 1} = overall passage rate from source S to destination d 1 & ( 2 ) \\ {α}_{S - d 2} = {α}_{k} * {α}_{a} * {α}_{d2} = overall passage rate from source S to destination d 2 & ( 3 ) \\ {α}_{S - d 3} = {α}_{k} * {α}_{b} * {α}_{d 3} = overall passage rate from source S to destination d 3 & ( 4 ) \\ {α}_{S - d 4} = {α}_{k} * {α}_{b} * {α}_{d 4} = overall passage rate from source S destination d 4 & ( 5 )\end{matrix}$$

In other cases, different subsets of measuring devices may be unavailable or unreliable. In such cases, step 305 may produce a similar set of linear or nonlinear equations that comprise a different set of hidden or unknown values, and wherein solutions to the similar set identifies a different set of unknown path gains or passage rates of the fluid-distribution system.

Consider, for example, a case wherein a loss occurs at an unknown location along an aggregate link S-b, wherein aggregate link S-b connects meter S 201 and meter b 213 through sublink 203 and sublink 209. If meter k 205 of FIG. 2 is unavailable or unreliable, a method that relies solely upon observable measurements to estimate a location or magnitude of a loss could use reliable measurements from meter S 201 and meter b 213 to identify a passage rate along aggregate link S-b between S 201 and b 213. But the unavailability of reliable measurements from meter k 205 prevents an accurate identification of individual passage rates along sublink 203 and sublink 209, making it difficult or impossible to identify the location of a loss with precision sufficient to determine which of sublinks 203 or 209 is lossy.

The method of step 305 might address this problem through the addition of linear equations (6)-(8). Equation (6) states a conservation law analogous to that of equation (1), but solves for a passage rate α_{S-b}, where α_{S-b} characterizes fluid flowing across aggregate link S-b from source location S 201 through intermediate location k 205 to destination location b 213.

Equation (7) states a similar conservation law that expresses an unknown value of a flow through point b 213, defining it as a sum of measurable flows at points d3 227 and d4 229. Equation (8) expresses passage rate α_{S-b} as a product of a passage rate of sublink 205 between S 201 and k 205 and a passage rate of sublink 209 between k 205 and b 213.

The resulting equations (6)-(8) enable the identification in step 307 of a set of possible values of α_{S-b} through straightforward mathematical procedures well-known to those skilled in the field of fluid-distribution system design or linear algebra.

$$\begin{matrix}m ( S , t 0 ) = \frac{m ( d 1 , t 1 )}{{α}_{S - d 1}} + \frac{m ( d 2 , t 2 )}{{α}_{S - d 2}} + \frac{m ( b , t 7 )}{{α}_{S - b}} & ( 6 ) \\ m ( b , t 7 ) = \frac{m ( d 3 , t 3 )}{{α}_{S - 3}} + \frac{m ( d 4 , t 4 )}{{α}_{S - d 4}} & ( 7 ) \\ {α}_{S - b} = {α}_{k} * {α}_{b} = overall passage rate from S 201 to b 213 & ( 8 )\end{matrix}$$

Solving a set of linear equations generated in step 305 may not yield a single solution. These equations may instead yield multiple sets of possible values for variables that represent passage rates or for variables that can be used to identify passage rates. Steps 307 and 309 reduce the number of possible solutions in such a solution set to one or more “sparse” solutions that are most likely to accurately estimate the location or magnitude of a loss.

In step 307, a system of linear equations generated in step 305 is solved in order to produce a solution set of possible values of passage rates that may not be directly derived from collected measurements. This system of linear equations may be solved through application of straightforward mathematical procedures well-known to those skilled in the fields of fluid-distribution system design or linear algebra.

In embodiments wherein a fluid-distribution system is described by a similar system of nonlinear equations, similar or analogous well-known mathematical procedures may be used to produce a similar solution set.

In step 309, a solution set of step 307 are optimized to yield a sparsest solution through application of mathematical techniques well-known to those skilled in the art of linear programming or combinatorial optimization, or by processing the solution set through a commercial optimization software package, such as IBM ILOG CPLEX Optimization Studio.

The method of step 309 is based on an assumption that losses in a fluid-distribution system are generally uncommon events that occur along a relatively small number of distribution links. This assumption bounds a set of solutions to a problem of identifying a passage rate along an unmetered path of a distribution link by limiting the set of solutions to a minimized set of “sparsest” solutions, wherein the limitation is a function of a constraint that the number of passage rates to be identified is small relative to the total number of passage rates that characterize a local topology of the fluid-distribution system.

In some implementations, the resource demands of a sparsity minimization procedure may be prohibitive. In such cases, less computationally intensive mathematical techniques that relax some constraints of a combinatorial sparsity minimization procedure may be substituted in order to approximate or identify a minimum solution.

These well-known, less computationally intensive, “relaxed” mathematical techniques may comprise L1 minimization, which may be performed upon a linear program that comprises known values and hidden values, and wherein, in embodiments of the present invention, a known value may comprise an accurate value reported by a measurement device and a hidden value may comprise a corrupted, unknown, unreliable, or unavailable measurement.

L1 optimization may be the best choice when a number of hidden values is small relative to a number of known values. But other well-known, less computationally intensive techniques may also be selected, and selection of such a technique may be a function of a characteristic of a measurement, such as the measurement's noise level, or may be a function of other characteristics of the distribution system.

These well-known, less computationally intensive, “relaxed” mathematical techniques may also comprise L2 minimization, which may be performed upon a program of nonlinear equations to select sparse solutions that minimize the magnitude of errors in variable values comprised by the nonlinear equations. L2 minimization may produce more accurate results in embodiments of the present invention wherein larger numbers of measurements have been collected and wherein errors in those measurements are known or presumed to exist, such as in a fluid-distribution system that comprises noisy or low-tolerance measurement devices.

Such implementations may comprise, but are not limited to, implementations wherein measuring devices do not produce accurate or consistent measurements, wherein measurements are not available from a location of the fluid-distribution system, wherein measurements are collected at times that do not fall within a particular threshold timespan, or wherein other omissions or known or presumed errors exist in measurements collected from measurement devices.

When an L1 minimization operation is performed upon a linear program derived in steps 305 and 307, the L1 minimization operation may identify a sparsest solution most likely to estimate accurate values for unmeasured or unreliable passage rates. When an L2 minimization operation is performed upon a nonlinear program derived in steps 305 and 307, the L2 minimization operation may identify a sparsest solution most likely to estimate accurate values for unmeasured or unreliable passage rates.

This “sparsity” embodiment of the present method, as described in FIG. 3, thus identifies and corrects unknown or inaccurate passage rates in a fluid-distribution system wherein some passage rates are not accurately measured, by minimizing errors in “hidden” unavailable or inaccurate measured values.

In cases where the sparsest solution is not unique or is not entirely correct, extrinsic factors or prior information, as described above, about the fluid-distribution network may be used to select a unique, correct solution from a set of sparse solutions identified by a minimization operation of step 309.

What is claimed is:

1. A method for estimating losses in a fluid-distribution system, wherein said fluid-distribution system comprises a plurality of locations and a plurality of distribution links, and wherein a first distribution link of said plurality of distribution links connects a first location of said plurality of locations to a second location of said plurality of locations, said method comprising:
a processor of a computer system receiving a plurality of measurements from a plurality of measurement devices, wherein a received measurement of said plurality of measurements identifies a characteristic of a fluid flowing through a measurement location of said plurality of locations, and wherein said plurality of measurements do not directly and accurately identify a fluid-loss location of said plurality of locations or a fluid-loss rate along a lossy distribution link of said plurality of distribution links; and
said processor analyzing said plurality of measurements to identify said fluid-loss location or said fluid-loss rate as a function of said plurality of measurements.

2. The method of claim 1, wherein said characteristic comprises flow volume, flow velocity, fluid pressure, fluid temperature, or some combination thereof.

3. The method of claim 1, wherein said analyzing further comprises said processor constructing a mathematical model that represents said fluid-distribution system, wherein said model comprises a plurality of nodes and a plurality of paths, and wherein a first node of said plurality of nodes represents said first location, a second node of said plurality of nodes represents said second location, and a first path of said plurality of paths represents said first distribution link.

4. The method of claim 1, wherein said analyzing further comprises generating and solving a set of equations in order to estimate an unknown passage rate along said lossy distribution link, wherein said unknown passage rate is a function of an unknown value of said characteristic of a fluid flowing through an endpoint location of said lossy distribution link, and wherein said characteristic of said fluid flowing through said endpoint location is not directly and accurately identified by said plurality of measurements.

5. The method of claim 4, wherein said analyzing further comprises minimizing measurement errors comprised by said equations in order to generate a sparse solution, and wherein said minimizing comprises an application of L0 minimization, L1 minimization, L2 minimization, a Markov chain Monte Carlo algorithm, a Gibbs sampling algorithm, junction tree-decomposition methods, a variational Bayesian method, belief propagation, other frequentist inferential procedures, laws of flow conservation, or a combination thereof.

6. The method of claim 5, wherein said analyzing further comprises a function of known physical characteristics of said fluid-distribution system, historical data about said fluid-distribution system, noise characteristics of said measurement devices, or a combination thereof.

7. A computer program product, comprising a computer-readable hardware storage device having a computer-readable program code stored therein, said program code configured to be executed by a processor of a computer system to implement a method for estimating losses in a fluid-distribution system, wherein said fluid-distribution system comprises a plurality of locations and a plurality of distribution links, and wherein a first distribution link of said plurality of distribution links connects a first location of said plurality of locations to a second location of said plurality of locations, said method comprising:
said processor of a computer system receiving a plurality of measurements from a plurality of measurement devices, wherein a received measurement of said plurality of measurements identifies a characteristic of a fluid flowing through a measurement location of said plurality of locations, and wherein said plurality of measurements do not directly and accurately identify a fluid-loss location of said plurality of locations or a fluid-loss rate along a lossy distribution link of said plurality of distribution links; and
said processor analyzing said plurality of measurements to identify said fluid-loss location or said fluid-loss rate as a function of said plurality of measurements.

8. The computer program product of claim 7, wherein said characteristic comprises flow volume, flow velocity, fluid pressure, fluid temperature, or some combination thereof.

9. The computer program product of claim 7, wherein said analyzing further comprises said processor constructing a mathematical model that represents said fluid-distribution system, wherein said model comprises a plurality of nodes and a plurality of paths, and wherein a first node of said plurality of nodes represents said first location, a second node of said plurality of nodes represents said second location, and a first path of said plurality of paths represents said first distribution link.

10. The computer program product of claim 7, wherein said analyzing further comprises generating and solving a set of equations in order to estimate an unknown passage rate along said lossy distribution link, wherein said unknown passage rate is a function of an unknown value of said characteristic of a fluid flowing through an endpoint location of said lossy distribution link, and wherein said characteristic of said fluid flowing through said endpoint location is not directly and accurately identified by said plurality of measurements.

11. The computer program product of claim 10, wherein said analyzing further comprises minimizing measurement errors comprised by said equations in order to generate a sparse solution, and wherein said minimizing comprises an application of L0 minimization, L1 minimization, L2 minimization, a Markov chain Monte Carlo algorithm, a Gibbs sampling algorithm, junction tree-decomposition methods, a variational Bayesian method, belief propagation, other frequentist inferential procedures, laws of flow conservation, or a combination thereof.

12. The computer program product of claim 11, wherein said analyzing further comprises a function of known physical characteristics of said fluid-distribution system, historical data about said fluid-distribution system, noise characteristics of said measurement devices, or a combination thereof.

13. A computer system comprising a processor, a memory coupled to said processor, and a computer-readable hardware storage device coupled to said processor, said storage device containing program code configured to be run by said processor via the memory to implement a method for estimating losses in a fluid-distribution system, wherein said fluid-distribution system comprises a plurality of locations and a plurality of distribution links, and wherein a first distribution link of said plurality of distribution links connects a first location of said plurality of locations to a second location of said plurality of locations, said method comprising:
said processor of a computer system receiving a plurality of measurements from a plurality of measurement devices, wherein a received measurement of said plurality of measurements identifies a characteristic of a fluid flowing through a measurement location of said plurality of locations, and wherein said plurality of measurements do not directly and accurately identify a fluid-loss location of said plurality of locations or a fluid-loss rate along a lossy distribution link of said plurality of distribution links; and
said processor analyzing said plurality of measurements to identify said fluid-loss location or said fluid-loss rate as a function of said plurality of measurements.

14. The system of claim 13, wherein said characteristic comprises flow volume, flow velocity, fluid pressure, fluid temperature, or some combination thereof.

15. The system of claim 13, wherein said analyzing further comprises said processor constructing a mathematical model that represents said fluid-distribution system, wherein said model comprises a plurality of nodes and a plurality of paths, and wherein a first node of said plurality of nodes represents said first location, a second node of said plurality of nodes represents said second location, and a first path of said plurality of paths represents said first distribution link.

16. The system of claim 13, wherein said analyzing further comprises generating and solving a set of equations in order to estimate an unknown passage rate along said lossy distribution link, wherein said unknown passage rate is a function of an unknown value of said characteristic of a fluid flowing through an endpoint location of said lossy distribution link, and wherein said characteristic of said fluid flowing through said endpoint location is not directly and accurately identified by said plurality of measurements.

17. The system of claim 16, wherein said analyzing further comprises minimizing measurement errors comprised by said equations in order to generate a sparse solution, and wherein said minimizing comprises an application of L0 minimization, L1 minimization, L2 minimization, a Markov chain Monte Carlo algorithm, a Gibbs sampling algorithm, junction tree-decomposition methods, a variational Bayesian method, belief propagation, other frequentist inferential procedures, laws of flow conservation, or a combination thereof.

18. The system of claim 17, wherein said analyzing further comprises a function of known physical characteristics of said fluid-distribution system, historical data about said fluid-distribution system, noise characteristics of said measurement devices, or a combination thereof.

19. A process for supporting computer infrastructure, said process comprising providing at least one support service for at least one of creating, integrating, hosting, maintaining, and deploying computer-readable program code in a computer system, wherein the program code in combination with said computer system is configured to implement a method for estimating losses in a fluid-distribution system, wherein said fluid-distribution system comprises a plurality of locations and a plurality of distribution links, and wherein a first distribution link of said plurality of distribution links connects a first location of said plurality of locations to a second location of said plurality of locations, said method comprising:
said processor of a computer system receiving a plurality of measurements from a plurality of measurement devices, wherein a received measurement of said plurality of measurements identifies a characteristic of a fluid flowing through a measurement location of said plurality of locations, and wherein said plurality of measurements do not directly and accurately identify a fluid-loss location of said plurality of locations or a fluid-loss rate along a lossy distribution link of said plurality of distribution links; and
said processor analyzing said plurality of measurements to identify said fluid-loss location or said fluid-loss rate as a function of said plurality of measurements.

20. The method of claim 19, wherein said characteristic comprises flow volume, flow velocity, fluid pressure, fluid temperature, or some combination thereof.

21. The method of claim 19, wherein said analyzing further comprises said processor constructing a mathematical model that represents said fluid-distribution system, wherein said model comprises a plurality of nodes and a plurality of paths, and wherein a first node of said plurality of nodes represents said first location, a second node of said plurality of nodes represents said second location, and a first path of said plurality of paths represents said first distribution link.

22. The method of claim 19, wherein said analyzing further comprises generating and solving a set of equations in order to estimate an unknown passage rate along said lossy distribution link, wherein said unknown passage rate is a function of an unknown value of said characteristic of a fluid flowing through an endpoint location of said lossy distribution link, and wherein said characteristic of said fluid flowing through said endpoint location is not directly and accurately identified by said plurality of measurements.

23. The method of claim 22, wherein said analyzing further comprises minimizing measurement errors comprised by said equations in order to generate a sparse solution, and wherein said minimizing comprises an application of L0 minimization, L1 minimization, L2 minimization, a Markov chain Monte Carlo algorithm, a Gibbs sampling algorithm, junction tree-decomposition methods, a variational Bayesian method, belief propagation, other frequentist inferential procedures, laws of flow conservation, or a combination thereof.

24. The method of claim 23, wherein said analyzing further comprises a function of known physical characteristics of said fluid-distribution system, historical data about said fluid-distribution system, noise characteristics of said measurement devices, or a combination thereof.
